(19) United States
(12) Patent Application Publication
(10) Pub. No.: US 2023/0059817 A1
(43) Pub. Date: Feb. 23, 2023

(54) CYCLIC OLEFIN COPOLYMER, CYCLIC OLEFIN-BASED RESIN COMPOSITION, CROSS-LINKED PRODUCT, AND FORMED ARTICLE

(71) Applicant: MITSUI CHEMICALS, INC., Minato-ku, Tokyo (JP)

(72) Inventors: Kazuoki NAKAI, Chiba-shi, Chiba (JP); Hirohiko MURASE, Iwakuni-shi, Yamaguchi (JP); Fumito TAKEUCHI, Chiba-shi, Chiba (JP)

(73) Assignee: MITSUI CHEMICALS, INC., Minato-ku, Tokyo (JP)

(21) Appl. No.: 17/785,123

(22) PCT Filed: Jan. 20, 2021
(86) PCT No.: PCT/JP2021/001817

§ 371 Date: Jun. 14, 2022

(30) Foreign Application Priority Data
Jan. 24, 2020 (JP) 2020-009678

(51) Int. Cl. C08L 23/08; C08F 236/20; C08F 232/08

(52) U.S. Cl. CPC C08L 23/0823; C08L 23/083; C08F 236/20; C08F 232/08; C08L 2203/16; C08L 2203/20

(57) ABSTRACT

A cyclic olefin copolymer includes one or more olefin-derived constituent units (A) represented by General Formula (I), one or more cyclic olefin-derived constituent units (C) represented by General

Formula (II), one or more cyclic non-conjugated diene-derived constituent units (B) represented by General Formula (III), and one or more cyclic olefin-derived constituent units (D) represented by General Formula (V), in which, when a total number of moles of the constituent units in the cyclic olefin copolymer is 100 mol %, a content of the constituent unit (C) is 5 mol % or more and 40 mol % or less.

### TECHNICAL FIELD

The present invention relates to a cyclic olefin copolymer, a cyclic olefin-based resin composition, a cross-linked product, and a formed article.

### BACKGROUND ART

Formed articles formed of cyclic olefin copolymers have, for example, excellent heat resistance, mechanical characteristics, transparency, dielectric characteristics, solvent resistance, formability, dimensional stability, and the like and are used in various fields. However, depending on the application, there may be a demand for higher heat resistance, solvent resistance, or mechanical strength and attempts are being made to further improve heat resistance, solvent resistance, and mechanical strength by cross-linking cyclic olefin copolymers using various methods such as sulfur cross-linking, organic peroxide cross-linking, electron beam cross-linking, and radiation cross-linking.

Examples of techniques relating to the cross-linking of cyclic olefin-based copolymers include the examples described in Patent Document 1 (International Publication No. WO2012/046443).

Patent Document 1 discloses a cyclic olefin copolymer having a cross-linkable group, the copolymer including an olefin-derived repeating unit, a cyclic non-conjugated diene-derived repeating unit, and a cyclic olefin-derived repeating unit, in which, in a case where the total number of moles of the repeating units is 100 mol %, 19 mol % to 36 mol % of the cyclic non-conjugated diene-derived repeating unit is included. Patent Document 1 describes that, when such a cyclic olefin copolymer is used, it is possible to obtain a cross-linked product with excellent dielectric property stability over time and heat resistance, as well as excellent transparency, mechanical characteristics, dielectric characteristics, and gas barrier properties.

### RELATED DOCUMENT

### Patent Document

[Patent Document 1] International Publication No. 2012/046443

### SUMMARY OF THE INVENTION

### Technical Problem

According to the studies of the present inventors, it was clear that the cyclic olefin copolymer described in Patent Document 1 has room for improvement in terms of solubility.

The present invention was made in view of the above circumstances and provides a cyclic olefin copolymer and a cyclic olefin-based resin composition having excellent solubility as well as able to realize a formed article with an excellent performance balance of dielectric characteristics and heat resistance.

### Solution to Problem

According to the present invention, a cyclic olefin copolymer, a cyclic olefin-based resin composition, a cross-linked product, and a formed article, which are shown below, are provided.

[1]

A cyclic olefin copolymer including one or more olefin-derived constituent units (A) represented by General Formula (I), one or more cyclic olefin-derived constituent units (C) represented by General Formula (II), one or more cyclic non-conjugated diene-derived constituent units (B) represented by General Formula (III), and one or more cyclic olefin-derived constituent units (D) represented by General Formula (V), in which, when a total number of moles of the constituent units in the cyclic olefin copolymer is 100 mol %, a content of the constituent unit (C) is 5 mol % or more and 40 mol % or less,

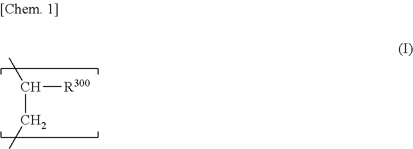

(in General Formula (I), R³⁰⁰ represents a hydrogen atom or a linear or branched hydrocarbon group having 1 to 29 carbon atoms),

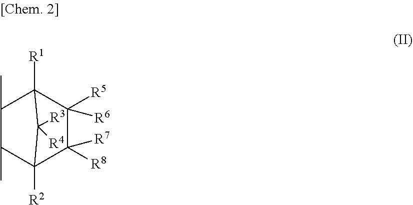

(in General Formula (II), R¹ to R⁸ are each independently a hydrogen atom, a halogen atom, or a hydrocarbon group having 4 or less carbon atoms, R⁵ to R⁸ may be bonded to each other to form a monocyclic ring and the monocyclic ring may have a double bond, and an alkylidene group may be formed by R⁵ and R⁶ or R⁷ and R⁸),

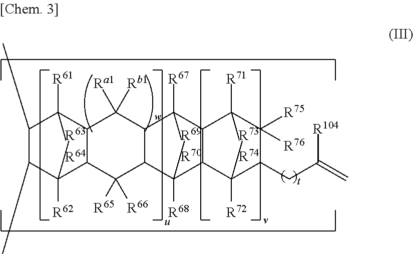

(in General Formula (III), u is 0 or 1, v is 0 or a positive integer, w is 0 or 1, R⁶¹ to R⁷⁶ and R^{a1} and R^{b1} may be the same as or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded with each other to form a monocyclic ring or polycyclic ring),

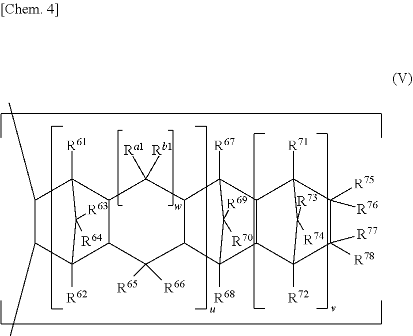

(in General Formula (V), u is 0 or 1, v is 0 or a positive integer, u+v is a positive integer, w is 0 or 1, R⁶¹ to R⁷⁸ and R^{a1} and R^{b1} maybe the same as or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or polycyclic ring).

[2]

The cyclic olefin copolymer according to [1], in which a ratio ((B+C)/D) of a sum of a content of the constituent unit (B) and a content of the constituent unit (C) to a content of the constituent unit (D) in the cyclic olefin copolymer is 1.75 or more.

[3]

The cyclic olefin copolymer according to [1] or [2], in which a ratio (B/(B+C+D)) of a content of the constituent unit (B) to a sum of a content of the constituent unit (B), a content of the constituent unit (C), and a content of the constituent unit (D) in the cyclic olefin copolymer is 0.75 or less.

[4]

The cyclic olefin copolymer according to any one of [1] to [3], in which a cyclic non-conjugated diene forming the cyclic non-conjugated diene-derived constituent unit (B) includes at least one selected from 5-vinyl-2-norbornene and 8-vinyl-9-methyltetracyclo[4.4.0.1^{2,5}.1^{7,10}]-3-dodecene.

[5]

The cyclic olefin copolymer according to any one of [1] to [4], in which a cyclic non-conjugated diene forming the cyclic non-conjugated diene-derived constituent unit (B) includes 5-vinyl-2-norbornene.

[6]

The cyclic olefin copolymer according to any one of [1] to [5], in which a cyclic olefin forming the cyclic olefin-derived constituent unit (C) includes bicyclo[2.2.1]-2-heptene.

[7]

The cyclic olefin copolymer according to any one of [1] to [6], in which a cyclic olefin forming the cyclic olefin-derived constituent unit (D) includes tetracyclo[4.4.0.1^{2,5}.1^{7,10}]-3-dodecene.

[8]

The cyclic olefin copolymer according to any one of [1] to [7], in which an olefin forming the olefin-derived constituent unit (A) includes ethylene.

[9]

A cyclic olefin-based resin composition including the cyclic olefin copolymer according to any one of [1] to [8].

[10]

The cyclic olefin-based resin composition according to [9], further including a solvent, in which the cyclic olefin-based resin composition is varnish-like.

[11]

The cyclic olefin-based resin composition according to [9] or [10], further including a radical polymerization initiator.

A cross-linked product formed by cross-linking the cyclic olefin copolymer according to any one of [1] to [8] or the cyclic olefin-based resin composition according to any one of [9] to [11].

[13]

A formed article including the cross-linked product according to [12].

[14]

The formed article according to [13] which is a film or sheet.

[15]

The formed article according to [13] or [14], which is a high frequency circuit substrate or a substrate for a liquid crystal display.

### Advantageous Effects of Invention

According to the present invention, it is possible to realize a formed article having an excellent performance balance of dielectric characteristics and heat resistance and to provide a cyclic olefin copolymer and a cyclic olefin-based resin composition having excellent solubility.

### DESCRIPTION OF EMBODIMENTS

A description will be given below of the present invention based on embodiments. In the present embodiment, “A to B” indicating a numerical range represents A or more and B or less unless otherwise specified.

[Cyclic Olefin Copolymer (P)]

A cyclic olefin copolymer (P) according to the present embodiment includes one or more olefin-derived constituent units (A) represented by General Formula (I), one or more cyclic olefin-derived constituent units (C) represented by General Formula (II), one or more cyclic non-conjugated diene-derived constituent units (B) represented by General Formula (III), and one or more cyclic olefin-derived constituent units (D) represented by General Formula (V).

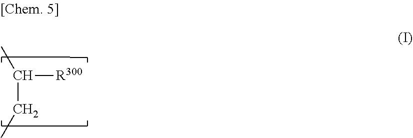

In General Formula (I), R³⁰⁰ represents a hydrogen atom or a linear or branched hydrocarbon group having 1 to 29 carbon atoms.

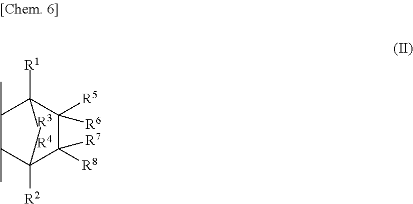

In General Formula (II), R¹ to R⁸ are each independently a hydrogen atom, a halogen atom, or a hydrocarbon group having 4 or less carbon atoms, R⁵ to R⁸ may be bonded to each other to form a monocyclic ring and the monocyclic ring may have a double bond, and an alkylidene group may be formed by R⁵ and R⁶ or R⁷ and R⁸.

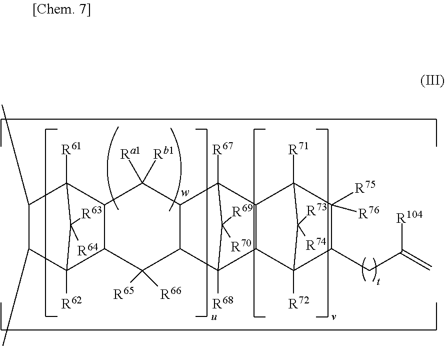

In General Formula (III), u is 0 or 1, vis 0 or a positive integer, preferably an integer of 0 or more and 2 or less, and more preferably 0 or 1, w is 0 or 1, R⁶¹ to R⁷⁶ and R^{a1} and R^{b1}, which may be the same or different, are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded with each other to form a monocyclic ring or polycyclic ring.

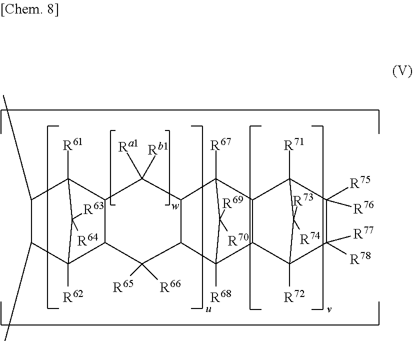

In General Formula (V), u is 0 or 1, v is 0 or a positive integer, preferably an integer of 0 or more and 2 or less, and more preferably 0 or 1, u+v is a positive integer, w is 0 or 1, R⁶¹ to R⁷⁸ and R^{a1} and R^{b1}, which may be the same or different, are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded with each other to form a monocyclic ring or polycyclic ring.

When the total number of moles of the constituent units in the cyclic olefin copolymer (P) is 100 mol %, the content of the constituent unit (C) is 5 mol % or more and 40 mol % or less.

The cyclic olefin copolymer (P) according to the present embodiment includes a constituent unit (A), a constituent unit (B), a constituent unit (C), and a constituent unit (D), and, due to the content of the constituent unit (C) being in the range described above, a cross-linked product (Q) obtained from the cyclic olefin copolymer (P) has excellent dielectric properties and heat resistance and, furthermore, the solubility of the cyclic olefin copolymer (P) in solvents is improved, thus, the formability becomes good and the product yield is increased. In other words, according to the present embodiment, it is possible to realize a formed article with an excellent performance balance of dielectric characteristics and heat resistance and to provide the cyclic olefin copolymer (P) and a cyclic olefin-based resin composition with excellent solubility.

<Constituent Unit (A)>

In General Formula (I), R³⁰⁰ represents a hydrogen atom or a linear or branched hydrocarbon group having 1 to 29 carbon atoms.

Examples of olefin monomers for forming the constituent unit (A) include ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, -4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, and the like.

From the viewpoint of obtaining a cross-linked product having superior heat resistance, mechanical characteristics, dielectric characteristics, transparency, and gas barrier properties, among the above, ethylene or propylene is preferable and ethylene is more preferable. One type of olefin monomer may be used alone to form the constituent unit (A) or two or more types may be used together.

In the cyclic olefin-based copolymer (P) according to the present embodiment, when the total number of moles of the constituent units in the cyclic olefin copolymer (P) is 100 mol %, the content of the constituent unit (A) is preferably 20 mol % or more and 80 mol % or less, more preferably 40 mol % or more and 60 mol % or less, and even more preferably 45 mol % or more and 55 mol % or less.

It is possible to measure the content of the constituent unit (A) by ¹H-NMR.

<Constituent Unit (C)>

In General Formula (II), R¹ to R⁸ are each independently a hydrogen atom, a halogen atom, or a hydrocarbon group having 4 or less carbon atoms. Here, the halogen atom is a fluorine atom, a chlorine atom, a bromine atom, or an iodine atom.

Examples of hydrocarbon group having 4 or less carbon atoms include alkyl groups such as methyl groups, ethyl groups, propyl groups, isopropyl groups, n-butyl groups, and isobutyl groups, and cycloalkyl groups such as cyclopropyl groups.

In addition, R⁵ to R⁸ may be bonded to each other to form a monocyclic ring and the monocyclic ring may have a double bond, and an alkylidene group may be formed by R⁵ and R⁶ or R⁷ and R⁸. The monocyclic rings formed here are exemplified as follows.

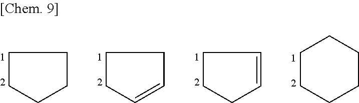

In the monocyclic ring described above, the carbon atoms numbered 1 or 2 are the carbon atoms forming the alicyclic structure to which R⁵ (R⁶) or R⁷ (R⁸) is bonded in General Formula (II).

In addition, the alkylidene group is specifically an ethylidene group, a propylidene group, or an isopropylidene group.

Examples of the cyclic olefin monomer for forming the constituent unit (C) include
bicyclo[2.2.1]-2-heptene (also referred to as norbornene), alkyls and/or alkylidene substituents thereof, for example,
5-methyl-2-norbornene, 5-dimethyl-2-norbornene,
5-ethyl-2-norbornene, 5-butyl-2-norbornene,
5-ethylidene-2-norbornene, and the like;
   polar group substituents of the above such as halogen;
   dicyclopentadiene, 2,3-dihydrodicyclopentadiene, and the like;
   dimethanoctahydronaphthalene, alkyls and/or alkylidene substituents thereof, polar group substituents such as halogens, carboxyl groups, and cyano groups, for example,
6-methyl-1,4:5,8-dimethano-1,4,4a,5,6,7,8,8a-octahydronaphthalene,
6-ethyl-1,4:5,8-dimethano-1,4,4a,5,6,7,8,8a-octahydronaphthalene,
6-ethylidene-1,4:5,8-dimethano-1,4,4a,5,6,7,8,8a-octahydronaphthalene,
6-chloro-1,4:5,8-dimethano-1,4,4a,5,6,7,8,8a-octahydronaphthalene,
6-cyano-1,4:5,8-dimethano-1,4,4a,5,6,7,8,8a-octahydronaphthalene,
6-pyridyl-1,4:5,8-dimethano-1,4,4a,5,6,7,8,8a-octahydronaphthalene,
6-methoxycarbonyl-1,4:5,8-dimethano-1,4,4a,5,6,7,8,8a-octahydronaphthalene, and the like;
   adducts of cyclopentadiene with tetrahydroindene or the like;
   3- to 4-mers of cyclopentadiene, for example,
4,9:5,8-dimethano-3a,4,4a,5,8,8a,9,9a-octahydro-1H-benzoindene,
4,11:5,10:6,9-trimethano-3a,4,4a,5,5a,6,9,9a,10,10a,11,11a-dodecahydro-1H-cyclopentaanthracene,
5-carboxymethylbicyclo[2.2.1]hept-2-ene,
5-methyl-5-carboxymethylbicyclo[2.2.1]hept-2-ene,
5-cyanobicyclo[2.2.1]hept-2-ene,
8-carboxymethyltetracyclo[4.4.0.1^{2.5}.1^{7.10}]-3-dodecene,
8-carboxyethyltetracyclo[4.4.0.1^{2.5}.1^{7.10}]-3-dodecene, 8-carboxy
n-propyltetracyclo[4.4.0.1^{2.5}.1^{7.10}]-3-dodecene,
8-carboxyisopropyltetracyclo[4.4.0.1^{2.5}.1^{7.10}]-3-dodecene,
8-carboxy n-butyltetracyclo[4.4.0.1^{2.5}.1^{7.10}]-3-dodecene,
8-methyl-8-carboxymethyltetracyclo[4.4.0.1^{2.5}.1^{7.10}]-3-dodecene,
8-methyl-8-carboxyethyltetracyclo[4.4.0.1^{2.5}.1^{7.10}]-3-dodecene,
8-methyl-8-carboxy n-propyltetracyclo[4.4.0.1^{2.5}.1^{7.10}]-3-dodecene,
8-methyl-8-carboxyisopropyltetracyclo[4.4.0.1^{2.5}.1^{7.10}]-3-dodecene,
8-methyl-8-carboxy n-butyltetracyclo[4.4.0.1^{2.5}.1^{7.10}]-3-dodecene; and the like. Among the above, bicyclo[2.2.1]-2-heptene is preferable.

One type of cyclic olefin monomer may be used alone to form the constituent unit (C) or two or more types may be used together.

In the cyclic olefin-based copolymer (P) according to the present embodiment, when the total number of moles of the constituent units in the cyclic olefin copolymer (P) is 100 mol %, the content of the constituent unit (C) is 5 mol % or more and 40 mol % or less, preferably 10 mol % or more and 35 mol % or less, and more preferably 15 mol % or more and 30 mol % or less.

It is possible to measure the content of the constituent unit (C) by ¹H-NMR.

<Constituent Unit (B)>

The cyclic non-conjugated diene monomer, which is the copolymerization raw material of the cyclic olefin-based copolymer (P) according to the present embodiment, is addition copolymerized to form a constituent unit represented by Formula (III). Specifically, a cyclic non-conjugated diene represented by General Formula (IIIa) corresponding to General Formula (III) is used.

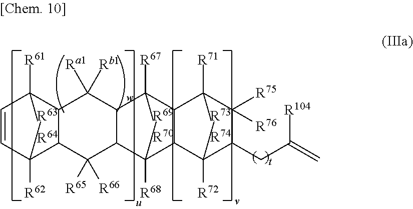

In General Formula (IIIa), u is 0 or 1, v is 0 or a positive integer, preferably an integer of 0 or more and 2 or less, and more preferably 0 or 1, w is 0 or 1, R⁶¹ to R⁷⁶ and R^{a1} and R^{b1} may be the same as or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded to each other to form a monocyclic ring or polycyclic ring.

The cyclic non-conjugated diene represented by General Formula (IIIa) is not particularly limited and examples thereof include the cyclic non-conjugated dienes represented by the chemical formulas below. Among the above, at least one selected from
5-vinyl-2-norbornene and
8-vinyl-9-methyltetracyclo[4.4.0.1^{2,5}.1^{7,10}]-3-dodecene is preferable and 5-vinyl-2-norbornene is more preferable.

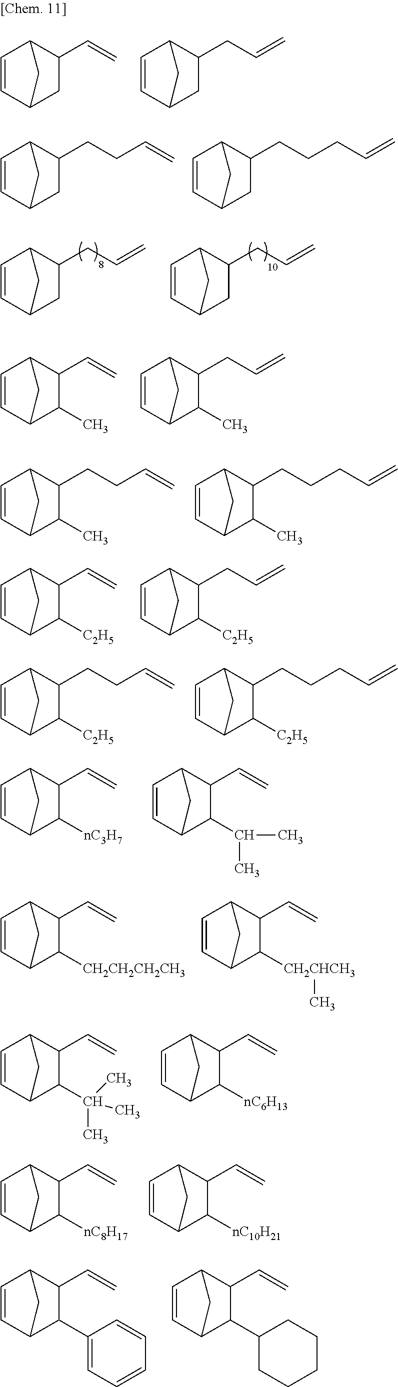

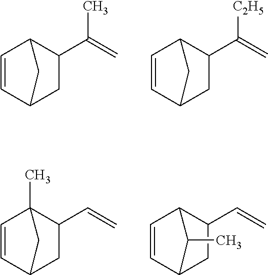

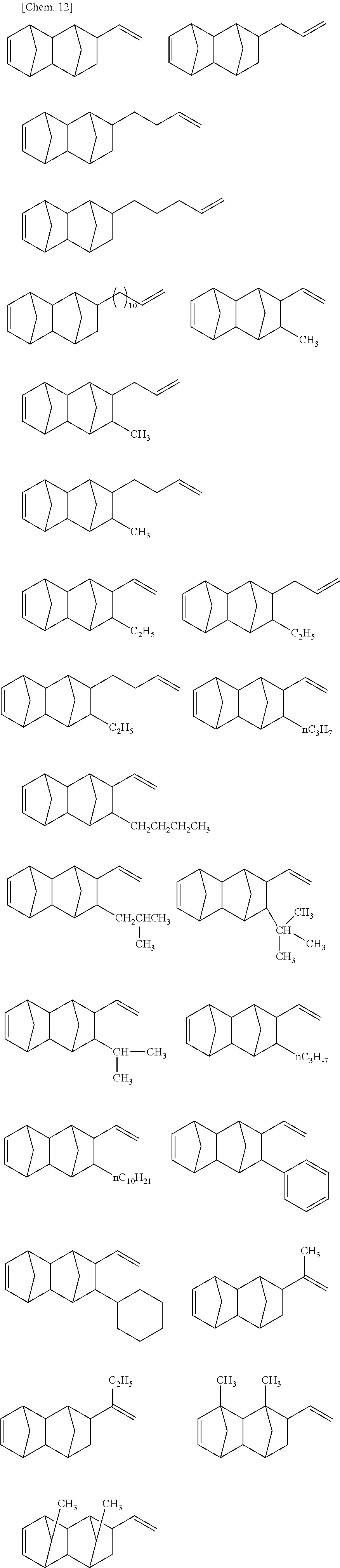

Specifically, it is also possible to represent the cyclic non-conjugated diene represented by General Formula (IIIa) by General Formula (IIIb).

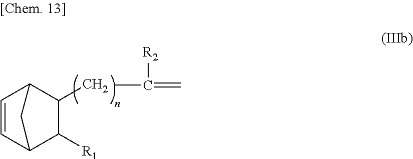

n in General Formula (IIIb) is an integer of 0 to 10, R₁ is a hydrogen atom or an alkyl group having 1 to 10 carbon atoms, and R₂ is a hydrogen atom or an alkyl group having 1 to 5 carbon atoms.

By including a cyclic non-conjugated diene-derived constituent unit represented by General Formula (III), the cyclic olefin-based copolymer (P) according to the present embodiment has a characteristic of having a double bond in a side chain portion, that is, a portion other than the main copolymerization chain.

In the cyclic olefin-based copolymer (P) according to the present embodiment, when the total number of moles of the constituent units in the cyclic olefin copolymer (P) is 100 mol %, the content of the constituent unit (B) is preferably 1 mol % or more and 35 mol % or less, more preferably 5 mol % or more and 30 mol % or less, and even more preferably 10 mol % or more and 25 mol % or less.

It is possible to measure the content of the constituent unit (B) by ¹H-NMR.

<Constituent Unit (D)>

The cyclic olefin monomer, which is the copolymerization raw material of the cyclic olefin-based copolymer (P) according to the present embodiment, is addition copolymerized to form a constituent unit represented by Formula (V). Specifically, a cyclic olefin monomer represented by General Formula (Va) corresponding to General Formula (V) is used.

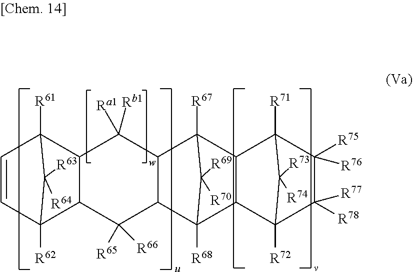

In General Formula (Va), u is 0 or 1, v is 0 or a positive integer, preferably an integer of 0 or more and 2 or less, and more preferably 0 or 1, u+v is a positive integer, w is 0 or 1, R⁶¹ to R⁷⁸ and R^{a1} and R^{b1}, which may be the same or different, are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded with each other to form a monocyclic ring or polycyclic ring.

As specific examples of the cyclic olefin represented by General Formula (Va), it is possible to use the compounds described in International Publication No. WO2006/118261. As the cyclic olefin represented by General Formula (Va),
tetracyclo[4.4.0.1^{2,5}.1^{7,10}]-3-dodecene (also referred to as tetracyclododecene) is preferable. Since tetracyclododecene has a rigid ring structure, the modulus of elasticity of the copolymer and the cross-linked product is easily retained, and since tetracyclododecene does not include a heterogeneous double bond structure, there is an advantage in that cross-linking is easily controlled.

In the cyclic olefin-based copolymer (P) according to the present embodiment, when the total number of moles of the constituent units in the cyclic olefin copolymer is 100 mol %, the content of the constituent unit (D) is preferably 1 mol % or more and 35 mol % or less, more preferably 3 mol % or more and 25 mol % or less, and even more preferably 5 mol % or more and 15 mol % or less.

It is possible to measure the content of the constituent unit (D) by ¹H-NMR .

In the cyclic olefin copolymer (P) according to the present embodiment, from the viewpoint of further improving the solubility, the ratio ((B+C)/D) of the sum of the content of the constituent unit (B) and the content of the constituent unit (C) in the cyclic olefin copolymer (P) to the content of the constituent unit (D) is preferably 1.75 or more, more preferably 3.50 or more, and even more preferably 5.00 or more. The upper limit of ((B+C)/D) is not particularly limited, but is, for example, 30.00 or less.

In the cyclic olefin copolymer (P) according to the present embodiment, from the viewpoint of further improving the dielectric loss tangent of the obtained formed article, the ratio (B/(B+C+D)) of the content of the constituent unit (B) in the cyclic olefin copolymer (P) to the sum of the content of the constituent unit (B), the content of the constituent unit (C), and the content of the constituent unit (D) is preferably 0.75 or less, more preferably 0.53 or less, and even more preferably 0.35 or less. The lower limit of (B/(B+C+D)) is not particularly limited, but is, for example, 0.01 or more.

For the cyclic olefin copolymer (P) according to the present embodiment, it is possible to control the comonomer content and glass transition point (Tg) thereof according to the charge ratio of the monomer depending on the desired application. The Tg of the cyclic olefin copolymer (P) is, for example, 300° C. or lower, preferably 250° C. or lower, and even more preferably 200° C. or lower, and preferably 140° C. or higher, more preferably 150° C. or higher, and even more preferably 160° C. or higher. When Tg is the above upper limit value or less, the melt formability of the cyclic olefin copolymer (P) and the solubility in a solvent when making a varnish are further improved. When the Tg is the above lower limit value or more, it is possible to further improve the heat resistance of the obtained formed article.

The ultimate viscosity [η] of the cyclic olefin copolymer (P) according to the present embodiment, measured in decalin at 135° C., is, for example, 0.01 to 15 dL/g, preferably 0.01 to 5 dL/g, and more preferably 0.01 to 3 dL/g. When the ultimate viscosity [n] is the above upper limit value or less, the formability and solubility in a solvent when making a varnish are improved. When the ultimate viscosity [n] is the above lower limit value or more, the heat resistance and mechanical characteristics of the cross-linked product (Q) obtained by cross-linking the cyclic olefin copolymer (P) or the cyclic olefin-based resin composition are improved. It is possible to control the ultimate viscosity [η] of the cyclic olefin copolymer (P) through polymerization conditions such as the polymerization catalyst, auxiliary catalysts, the added amount of H₂, and the polymerization temperature.

[Method For Manufacturing Cyclic Olefin Copolymer (P)]

It is possible to manufacture the cyclic olefin copolymer (P) according to the present embodiment, for example, according to the method for manufacturing a cyclic olefin copolymer described in paragraphs 0075 to 0219 of International Publication No. 2012/046443. Details will not be repeated here.

[Cyclic Olefin-Based Resin Composition]

The cyclic olefin-based resin composition according to the present embodiment includes the cyclic olefin copolymer (P) according to the present embodiment.

In addition, various additives may be added to the cyclic olefin-based resin composition according to the present embodiment according to the purpose. The added amounts of the additives are appropriately selected according to the application, in a range in which the purpose of the present invention is not impaired.

Examples of the additives include one or two or more additives selected from the group consisting of radical polymerization initiators, elastomers, heat resistant stabilizers, weather stabilizers, radiation resistance agents, plasticizers, lubricants, mold releasing agents, nucleating agents, friction and wear property improvers, flame retardants, foaming agents, anti-static agents, coloring agents, anti-fogging agents, anti-blocking agents, anti-impact agents, surface wetting improvers, fillers, hydrochloric acid absorbers, and metal deactivators.

It is possible to prepare the cyclic olefin-based resin composition according to the present embodiment, for example, by mixing the cyclic olefin copolymer (P) and various additives as necessary. As the mixing method, it is possible to adopt a method of melt blending in an extruder or the like, a solution blending method in which dissolving and dispersing are performed in a suitable solvent, such as a saturated hydrocarbon such as heptane, hexane, decane, or cyclohexane; or an aromatic hydrocarbon such as toluene, benzene, or xylene, or the like; and the like.

It is possible to make the cyclic olefin-based resin composition according to the present embodiment varnish-like by mixing with a solvent.

The solvent for preparing the varnish-like cyclic olefin-based resin composition is not particularly limited as long as it does not impair solubility or affinity with respect to the cyclic olefin copolymer (P). Preferably used solvents are, for example,
saturated hydrocarbons such as heptane, hexane, octane, and decane;
alicyclic hydrocarbons such as cyclohexane, methylcyclohexane, and decahydronaphthalene;
aromatic hydrocarbons such as toluene, benzene, xylene, mesitylene, and pseudocumene;
alcohols such as methanol, ethanol, isopropyl alcohol, butanol, pentanol, hexanol, propanediol, and phenol;
ketone solvents such as acetone, methyl isobutyl ketone, methyl ethyl ketone, pentanone, hexanone, cyclohexanone, isophorone, and acetophenone;
cellosolves such as methyl cellosolve and ethyl cellosolve;
esters such as methyl acetate, ethyl acetate, butyl acetate, methyl propionate, and butyl formate;
halogenated hydrocarbons such as trichloroethylene, dichloroethylene, and chlorobenzene, and the like.

Preferably, heptane, decane, cyclohexane, methylcyclohexane, decahydronaphthalene, toluene, benzene, xylene, mesitylene, and pseudocumene are used. It is possible to use these solvents alone or as a mixture of two or more in any ratio.

In the present embodiment, the method for producing the varnish-like cyclic olefin-based resin composition may be carried out by any method, but usually includes a step of mixing the cyclic olefin copolymer (P) and the solvent. The order of the components in the mixing of the respective components is not limited and the mixing is able to be carried out by any method such as in batches or separately. The apparatus for preparing the varnish is also not limited and the preparation may be carried out by any batch type or continuous type apparatus capable of stirring and mixing. It is possible to arbitrarily select the temperature when preparing the varnish within a range from room temperature to the boiling point of the solvent.

The varnish may be prepared by using the reaction solution as the solvent as is when the cyclic olefin copolymer (P) is obtained.

[Cross-Linked Product (Q)]

The cross-linked product (Q) according to the present embodiment is obtained by cross-linking the cyclic olefin copolymer (P) according to the present embodiment or the cyclic olefin-based resin composition according to the present embodiment. The method for cross-linking the cyclic olefin copolymer (P) according to the present embodiment or the cyclic olefin-based resin composition according to the present embodiment is not particularly limited and examples thereof include a method of cross-linking while molding or after molding into an arbitrary shape using a radical polymerization initiator, sulfur, a hydrosilyl group-containing compound, or electron beams or other radiation, or the like.

When cross-linking with a radical polymerization initiator, it is possible to directly apply a cross-linking method using a normal radical polymerization initiator applied using a polyolefin. That is, a radical polymerization initiator such as dicumyl peroxide is blended into the cyclic olefin copolymer (P) or the cyclic olefin-based resin composition, heated, and subjected to cross-linking. The blending ratio of the radical polymerization initiator is not particularly limited, but is usually 0. 02 to 20 parts by mass per 100 parts by mass of the cyclic olefin copolymer (P), preferably 0.05 to 10 parts by mass, and even more preferably 0.5 to 10 parts by mass. When the blending ratio of the radical polymerization initiator is the above upper limit value or less, it is possible to improve the dielectric characteristics of the cross-linked product (Q) and, when the blending ratio is the above lower limit value or more, it is possible to improve the heat resistance and mechanical properties of the cross-linked product (Q).

As the radical polymerization initiator, it is possible to use known thermal radical polymerization initiators, photo radical polymerization initiators, or combinations thereof. Among these radical polymerization initiators, in a case where a thermal radical polymerization initiator is used, the 10-hour half-life temperature is usually 80° C. or higher and preferably 120° C. or higher from the viewpoint of storage stability. Examples of such initiators include dialkyl peroxides such as dicumyl peroxide, t-butyl cumyl peroxide, 2,5-bis(t-butylperoxy) 2,5-dimethylhexane, 2,5-bis(t-butylperoxy) 2,5-dimethyl-3-hexyne, di-t-butyl peroxide, isopropyl cumyl-t-butyl peroxide, and bis (60 -t-butylperoxy isopropyl)benzene;
peroxy ketals such as 1,1-bis(t-butylperoxy) cyclohexane,
1,1-bis(t-butylperoxy) 3,3,5-trimethylcyclohexane,
1,1-bis(t-butylperoxy) cyclododecene,
n-butyl-4,4-bis(t-butylperoxy) valerate,
ethyl-3,3-bis(t-butylperoxy) butyrate,
3,3,6,6,9,9-hexamethyl-1,2,4,5-tetraoxycyclononane; peroxy esters such as bis(t-butylperoxy) isophthalate, t-butylperoxybenzoate, and t-butylperoxyacetate; hydroperoxides such as t-butyl hydroperoxide, t-hexyl hydroperoxide, cumin hydroperoxide,
1,1,3,3-tetramethylbutyl hydroperoxide, diisopropylbenzene hydroperoxide, and p-menthane hydroperoxide; bibenzyl compounds such as 2,3-dimethyl-2,3-diphenylbutane;
3,3,5,7,7-pentamethyl-1,2,4-trioxepane, and the like.

Specific examples of photo radical polymerization initiators in the radical polymerization initiators include benzoin alkyl ether, benzyl dimethyl ketal, 1-hydroxycyclohexyl phenyl ketone, 2-hydroxy-2-methyl-1-phenylpropane-1-on, benzophenone, methylbenzoylformate, isopropylthioxanthone, mixtures of two or more kinds thereof, and the like. In addition, it is also possible to use sensitizers together with these photo radical polymerization initiators. Examples of sensitizers include carbonyl compounds such as anthraquinone, 1,2-naphthoquinone, 1,4-naphthoquinone, benzanthrone, p,p′-tetramethyldiaminobenzophenone, and chloranil, nitro compounds such as nitrobenzene, p-dinitrobenzene, and 2-nitrofluorene, aromatic hydrocarbons such as anthracene and chrysene, sulfur compounds such as diphenyldisulfide, nitrogen compounds such as nitroaniline, 2-chloro-4-nitroaniline, 5-nitro-2-aminotoluene, and tetracyanoethylene, and the like.

In a case of cross-linking with sulfur or the like, the cyclic olefin-based resin composition is blended with a sulfur-based compound, and, as necessary, a vulcanization accelerator and a vulcanization acceleration aid, and heated to perform a cross-linking reaction. Although the blending amount of the sulfur-based compound is not particularly limited, in terms of efficiently advancing the cross-linking reaction, improving the physical properties of the obtained cross-linked product, economy, and the like, the sulfur-based compound is usually used in a range of 0.1 to 10 parts by mass with respect to 100 parts by mass of the cyclic olefin copolymer (P) and preferably in the range of 0.3 to 5 parts by mass, and in a case of being used together with a vulcanization accelerator or a vulcanization acceleration aid, usually in a range of 0.1 to 20 parts by mass and preferably 0.2 to 10 parts by mass.

It is possible to use various known sulfur-based compounds to cause the cross-linking reaction and examples thereof include sulfur, sulfur monochloride, sulfur dichloride, morpholine disulfide, alkylphenol disulfide, tetramethylthiuram disulfide, selenium dimethyldithiocarbamate, and the like. In addition, it is also possible to use various kinds of vulcanization accelerators and examples thereof include thiazole-based kinds such as
N-cyclohexyl-2-benzothiazole-sulfenamide,
N-oxydiethylene-2-benzothiazole-sulfenamide,
N,N-diisopropyl-2-benzothiazole sulfenamide,
2-mercaptobenzothiazole,
2-(2,4-dinitrophenyl)mercaptobenzothiazole,
2-(2,6-diethyl-4-morpholinothio)benzothiazole, and benzothiazyl-disulfide; guanidine-based kinds such as diphenyl guanidine, triphenyl guanidine, di-ortho-tolyl guanidine, ortho-tolyl biguanide, and diphenyl guanidine phthalate; acetaldehyde-aniline reaction products; butylaldehyde-aniline condensate; aldehyde amine or aldehyde ammonia-based kinds such as hexamethylenetetramine and acetaldehyde ammonia; imidazoline-based kinds such as 2-mercaptoimidazoline; thiourea-based kinds such as thiocarbanilide, diethyl thiourea dibutyl thiourea, trimethyl thiourea, and diortho-tolyl thiourea; thiuram-based kinds such as tetramethylthiuram monosulfide, tetramethylthiuram disulfide, tetraethylthiuram disulfide, tetrabutylthiuram disulfide, and dipentamethylenethiuram tetrasulfide; dithio acid salt-based kinds such as zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, and tellurium diethyldithiocarbamate; xanthate-based kinds such as zinc dibutyl xanthate; and the like.

Examples of vulcanization acceleration aids include metal oxide-based kinds such as zinc oxide, activated zinc oxide, zinc carbonate, complex zinc oxide, magnesium oxide, litharge, red lead, and basic lead carbonate, fatty acid-based kinds such as stearic acid, oleic acid, lauric acid, and lead stearate, organic amine glycol-based kinds such as triethanol amine, and diethylene glycol, and the like.

The temperature at which the cyclic olefin copolymer (P) or cyclic olefin-based resin composition is cross-linked by both radical polymerization initiator cross-linking and sulfur cross-linking is usually 100 to 300° C., preferably 120 to 250° C., and more preferably 120 to 220° C. and the cross-linking may be carried out by changing the temperature in stages. When the temperature is the above lower limit value or more, it is possible for the cross-linking to proceed sufficiently. In addition, when the temperature is the above upper limit value or less, it is possible to suppress coloration of the obtained cross-linked product and to simplify the process. As a reference, it is generally not possible for polybutadiene, which is a typical double bond-containing polymer, to be cross-linked under the conditions as described above and cross-linking conditions at high temperature such as 300° C. are necessary.

It is also possible for the cyclic olefin copolymer (P) or cyclic olefin-based resin composition according to the present embodiment to be cross-linked using a hydrosilyl group-containing compound having at least two hydrosilyl groups in one molecule. It is possible to carry out cross-linking using a hydrosilyl group-containing compound, for example, according to the method described in Japanese Unexamined Patent Publication No. 2015-193680. Details will not be repeated here.

Methods of cross-linking using electron beams or other radiation have the advantage of not limiting the temperature and fluidity at the time of molding and examples of radiation include electron beams, gamma rays, UV, and the like.

In either case of a method using a radical polymerization initiator, sulfur, a hydrosilyl group-containing compound, or the like, or a method of cross-linking using radiation, it is possible to carry out the cross-linking with a cross-linking aid.

The cross-linking aid is not particularly limited and examples thereof include oximes such as p-quinonedioxime and p,p′-dibenzoylquinonedioxime; acrylates or methacrylates such as ethylene dimethacrylate, polyethylene glycol dimethacrylate, trimethylolpropane trimethacrylate, cyclohexyl methacrylate, acrylic acid/zinc oxide mixture, and allyl methacrylate; vinyl monomers such as divinylbenzene, vinyltoluene, and vinylpyridine; allyl compounds such as hexamethylene diallyl nadimide, diallyl itaconate, diallyl phthalate, diallyl isophthalate, diallyl monoglycidyl isocyanurate, triallyl cyanurate, and triallyl isocyanurate; maleimide compounds such as N,N′-m-phenylene bismaleimide, N,N′-(4,4′-methylene diphenylene)dimaleimide, and the like; cyclic non-conjugated dienes such as vinyl norbornene, ethylidene norbornene, and dicyclopentadiene.

These cross-linking aids maybe used alone or use in combination is also possible.

It is possible to blend the cross-linked product (Q) according to the present embodiment with heat resistant stabilizers, weather stabilizers, anti-static agents, slip agents, anti-blocking agents, anti-fogging agents, lubricants, dyes, pigments, natural oils, synthetic oils, waxes, organic or inorganic fillers, and the like, as necessary, to an extent where the purpose of the present invention is not impaired and the blending ratio thereof is an appropriate amount.

Specific examples of stabilizers to be blended as arbitrary components include
phenol-based antioxidants such as
tetrakis[methylene-3(3,5-di-t-butyl-4-hydroxyphenyl)propionate]methane, β-(3,5-di-t-butyl-4-hydroxyphenyl)propionic acid alkyl ester,
2,2′-oxamidobis[ethyl-3(3,5-di-t-butyl-4-hydroxyphenyl)propionate;
fatty acid metal salts such as zinc stearate, calcium stearate, and calcium 12-hydroxystearate;
polyhydric alcohol fatty acid esters such as glycerin monostearate, glycerin monolaurate, glycerin distearate, pentaerythritol monostearate, pentaerythritol distearate, and pentaerythritol tristearate; and the like.

The above may be blended alone or blended in a combination and examples thereof include a combination of
tetrakis[methylene-3(3,5-di-t-butyl-4-hydroxyphenyl)propionate]methane with zinc stearate and glycerin monostearate, or the like.

Examples of organic or inorganic fillers include silica, silica earth, alumina, titanium oxide, magnesium oxide, pumice powder, pumice balloon, aluminum hydroxide, magnesium hydroxide, basic magnesium carbonate, dolomite, calcium sulfate, potassium titanate, barium sulfate, calcium sulfite, talc, clay, mica, asbestos, glass fibers, glass flakes, glass beads, calcium silicate, montmorillonite, bentonite, graphite, aluminum powder, molybdenum sulfide, boron fibers, silicon carbide fibers, polyethylene fibers, polypropylene fibers, polyester fibers, polyamide fibers, and the like.

To mix the cross-linked product (Q) with various additives, it is possible to adopt a method for melt blending the cyclic olefin copolymer (P) and various additives using an extruder or the like, or a solution blending method in which the cyclic olefin copolymer (P) and various additives are dissolved and dispersed in a suitable solvent, for example, a saturated hydrocarbon such as heptane, hexane, decane, or cyclohexane; or an aromatic hydrocarbon such as toluene, benzene, or xylene, or the like.

It is also possible for the cross-linking reaction to be carried out on a mixture of the cyclic olefin-based resin composition and a compound such as the above radical polymerization initiator, sulfur, hydrosilyl group-containing compound or the like in a molten state, for the cross-linking reaction to be carried out on the mixture in a dissolved state of being dissolved or dispersed in a solvent, or for the cross-linking reaction to be further advanced after volatilizing the solvent from a dissolved state dissolved in a solvent to mold an arbitrary shape such as a film or a coating.

In a case where the reaction is carried out in the molten state, the raw material mixture is melt-kneaded and reacted using a kneading apparatus such as a mixing roll, a Banbury mixer, an extruder, a kneader, or a continuous mixer. In addition, it is also possible to further advance the cross-linking reaction after molding by an arbitrary method.

As a solvent to be used for carrying out the reaction in a dissolved state, it is possible to use the same solvent as used in the solution blending method.

In a case where the cross-linking reaction is carried out using electron beams, other radiation, or UV, it is possible for the reaction to be carried out after shaping by an arbitrary method.

[Formed Article]

The formed article according to the present embodiment includes the cross-linked product (Q) according to the present embodiment.

The formed article according to the present embodiment is, for example, a film or a sheet.

As a method of forming a film or a sheet using the cyclic olefin copolymer (P) according to the present embodiment or the cyclic olefin-based resin composition according to the present embodiment, it is possible to apply various known methods. Examples thereof include a method in which the varnish described above is coated on a support base material such as a thermoplastic resin film, dried, and then subjected to a heat treatment or the like to cross-link and form the cyclic olefin copolymer (P) according to the present embodiment or the cyclic olefin-based resin composition according to the present embodiment. The method of coating the varnish on the support base material is not particularly limited and examples thereof include coating using a spin coater, coating using a spray coater, coating using a bar coater, and the like.

In addition, examples thereof also include a method of melt-molding the cyclic olefin copolymer (P) according to the present embodiment or the cyclic olefin-based resin composition according to the present embodiment to obtain a film or sheet.

It is possible to use the film or sheet of the present embodiment for various purposes as a laminate by lamination on a base material. As a method for forming the laminate of the present embodiment, it is possible to apply various known methods.

For example, it is possible to produce a laminate by laminating a film or sheet manufactured by the method described above on a base material and carrying out heating and curing by pressing or the like as necessary.

In addition, it is also possible to produce a laminate by laminating an electrically insulating layer including the cross-linked product described above on a conductor layer.

The cyclic olefin copolymer (P) according to the present embodiment or the cyclic olefin-based resin composition according to the present embodiment may be formed on the surface layers of various multi-layer formed articles or multi-layer laminated films. At this time, the resin layer formed from the cyclic olefin copolymer (P) according to the present embodiment or the cyclic olefin-based resin composition according to the present embodiment is preferably 100 μm or less.

Examples of the various multi-layer formed articles or multi-layer laminated films include multi-layer formed articles for optical lenses in which the cyclic olefin copolymer (P) according to the present embodiment or the cyclic olefin-based resin composition according to the present embodiment is formed on the surface of a resin optical lens, multi-layer gas barrier films formed of the cyclic olefin copolymer (P) according to the present embodiment or the cyclic olefin-based resin composition according to the present embodiment for imparting gas barrier properties to a resin film surface such as a PET film or a PE film, and the like.

In addition, the prepreg of the present embodiment is formed by combining the cyclic olefin copolymer (P) according to the present embodiment or the cyclic olefin-based resin composition according to the present embodiment and a sheet-like fiber base material.

The method for manufacturing the prepreg is not particularly limited and it is possible to apply various known methods. Examples thereof include a method including a step of impregnating the varnish described above into a sheet-like fiber base material to obtain an impregnated body and a step of heating the obtained impregnated body and drying the solvent included in the varnish.

It is possible to carry out the impregnation of the varnish into the sheet-like fiber base material, for example, by coating a predetermined amount of varnish on the sheet-like fiber base material by a known method such as spray coating, dip coating, roll coating, curtain coating, die coating, and slit coating, overlaying a protective film thereon as necessary, and carrying out pressing with a roller or the like thereon from the upper side.

In addition, the step of heating the impregnated body and drying the solvent included in the varnish described above is not particularly limited and examples thereof include a method such as batchwise drying in air or nitrogen with a blower dryer or drying by heating in a heating furnace in a subsequent step.

In the present embodiment, after the varnish is impregnated into the sheet-like fiber base material, the obtained impregnated body is heated to a predetermined temperature to evaporate the solvent included in the varnish to obtain a prepreg.

As the fibers of the sheet-like fiber base material according to the present embodiment, it is possible to use inorganic and/or organic fibers without particular limitation and examples thereof include organic fibers such as polyethylene terephthalate (PET) fibers, aramid fibers, ultra-high molecular polyethylene fibers, polyamide (nylon) fibers, and liquid crystal polyester fibers; inorganic fibers such as glass fibers, carbon fibers, alumina fibers, tungsten fibers, molybdenum fibers, titanium fibers, steel fibers, boron fibers, silicon carbide fibers, and silica fibers, and the like.

Among these, organic fibers and glass fibers are preferable and aramid fibers, liquid crystal polyester fibers, and glass fibers are preferable. Examples of glass fibers include E glass, NE glass, S glass, D glass, H glass, T glass, and the like.

Impregnation of the varnish into the sheet-like fiber base material is carried out, for example, by immersion and coating. The impregnation may be repeated a plurality of times as necessary.

These sheet-like fiber base materials are able to be used singly or in a combination of two or more and the usage amount of the sheet-like fiber base material is appropriately selected according to demands, but it is usually in a range of 10 to 90% by mass in the prepreg or laminate, preferably 20 to 80% by mass, and more preferably 30 to 70% by mass. Within this range, the dielectric characteristics and the mechanical strength of the obtained laminate are highly balanced, which is preferable.

The thickness of the prepreg according to the present embodiment is appropriately selected according to the purpose of use, but is usually 0.001 to 10 mm, preferably 0.005 to 1 mm, and more preferably 0.01 to 0.5 mm. Within this range, the shaping properties at the time of lamination and the properties such as mechanical strength and toughness of the laminate obtained by curing are sufficiently exhibited, which is preferable.

The cyclic olefin copolymer (P) according to the present embodiment or the cyclic olefin-based resin composition according to the present embodiment is excellent in dielectric characteristics, heat resistance, mechanical properties and the like and is thus able to be suitably used for a circuit substrate.

It is possible to adopt generally known methods as a method for producing the circuit substrate without particular limitation, for example, a film, a sheet, or a prepreg produced by the method described above is heated and cured by a lamination press or the like to form an electrically insulating layer. Next, conductor layers are laminated on the obtained electrically insulating layer by a known method to produce a laminate. Thereafter, it is possible to obtain a circuit substrate by circuit processing the conductor layer in the laminate or the like.

It is possible to use metals such as copper, aluminum, nickel, gold, silver, stainless steel, or the like as the metal for the conductor layer. Examples of the method for forming the conductor layer include a method in which the metal is formed into a foil or the like and thermally fused onto the electrically insulating layer, a method in which a metal is formed into a foil or the like and bonded to the electrically insulating layer using an adhesive, a method of forming a conductor layer formed of the metal on an electrically insulating layer by a method such as sputtering, vapor deposition, or plating, and the like. As the form of the circuit substrate, either a single-sided board or a double-sided board may be used.

It is possible to use such a circuit substrate as an electronic device, for example, by mounting electronic parts such as semiconductor elements thereon. It is possible to produce electronic devices based on known information.

Examples of such electronic devices include ICT infrastructure equipment such as servers, routers, supercomputers, mainframes, and workstations; antennas such as GPS antennas, antennas for radio base stations, millimeter wave antennas, and RFID antennas; communication devices such as mobile phones, smartphones, PHSs, PDAs, and tablet terminals; digital devices such as personal computers, televisions, digital cameras, digital video cameras, POS terminals, wearable terminals, and digital media players; vehicle-mounted electronic devices such as electronic control system devices, vehicle-mounted communication devices, car navigation devices, millimeter wave radars, and in-vehicle camera modules; semiconductor testing devices, high-frequency measurement devices, and the like; and the like.

In addition, it is possible to obtain a foamed product by cross-linking and foaming the cyclic olefin copolymer (P) according to the present embodiment or the cyclic olefin-based resin composition according to the present embodiment. At this time, the foaming agent described above maybe added to the cyclic olefin-based resin composition.

[Uses]

Since the cross-linked product (Q) according to the present embodiment is excellent in solvent resistance, heat resistance, mechanical strength, and transparency, the formed article formed of the cross-linked product (Q) is able to be used for applications such as optical fibers, optical waveguides, optical disc substrates, optical filters, lenses, optical adhesives, PDP optical filters, coating materials for organic EL, base film base materials for solar cells in the aerospace field, coating materials for solar cells and thermal control systems, semiconductor elements, light emitting diodes, electronic elements such as various types of memory, a hybrid IC, an MCM, a circuit substrate, a prepreg or a laminate used for forming an insulating layer of a circuit substrate, overcoat materials or interlayer insulating materials for display components or the like, substrates for liquid crystal displays or solar cells, medical instruments, automobile members, mold releasing agents, resin modifiers, transparent substrates for displays, members for lithium-ion batteries, semiconductor process members, film capacitors, gas barrier coating materials, electric wire coating materials, automobile members, aerospace members, process materials for semiconductors, wire coating materials, members for lithium-ion batteries, members for fuel cells, capacitor films, flexible display members, anchor coat materials, transparent adhesives, modified materials, cross-linking aids, medical containers, medical catheter members, waterproof sealing materials, releasing materials, hard coat materials, and foam modifiers.

In particular, since the present invention is excellent in the stability over time of the dielectric characteristics and is also excellent in solvent resistance, heat resistance, transparency, mechanical characteristics, and the like, it is possible to suitably use the present invention for high frequency applications such as high frequency circuit substrates. Furthermore, since the present invention is also excellent in the gas barrier property, it is possible to suitably use the present invention as a substrate for a liquid crystal display, or a substrate, film, or sheet of a solar cell.

Although the embodiments of the present invention are described above, these are examples of the present invention and it is also possible to adopt various configurations other than those described above.

In addition, the present invention is not limited to the above-described embodiments and variations, improvements, and the like within the scope of achieving the object of the present invention are included in the present invention.

### EXAMPLES

A more detailed description will be given below of the present invention with reference to Synthesis Examples and Examples, but the present invention is not limited in any way thereby.

The compositions and glass transition points (Tg) of the cyclic olefin copolymers (P) used in the Synthesis Examples, the Examples, and the Comparative Examples were measured by the methods described below.

[Method For Measuring Content of Each Constituent Unit Forming Cyclic Olefin-Based Copolymer]

The contents of the ethylene-derived constituent unit (A), the norbornene-derived constituent unit (C), the 5-vinyl-2-norbornene-derived constituent unit (B), and the tetracyclododecene-derived constituent unit (D) were measured using an “EXcalibur 270” nuclear magnetic resonance apparatus manufactured by JEOL Ltd., under the conditions described below.
Solvent: Heavy tetrachloroethane
Sample concentration: 30 to 40 g/L-solvent
Pulse repetition time: 5.5 seconds
Number of integrations: 16 to 64 times

Measurement temperature: Room temperature

The contents of the ethylene-derived constituent unit (A), the norbornene-derived constituent unit (C), the 5-vinyl-2-norbornene-derived constituent unit (B), and the tetracyclododecene-derived constituent unit (D) forming the cyclic olefin-based copolymer were each quantified by ¹H-NMR spectra, which were measured under the conditions described above.

The formed articles (films) obtained in the Examples and Comparative Examples were evaluated by the following method.

Evaluation of dielectric loss tangent: The films obtained in Examples and Comparative Examples were evaluated for dielectric loss tangent at 10 GHz by the cylindrical cavity resonator method.

Tg measurement: Solid-state viscoelastic temperature dispersion measurement of the obtained films was performed and the tan 6 peak temperature was set as Tg. Measurement was performed under the following conditions.
Apparatus: RSA-III (manufactured by T.A. Instruments)
Deformation mode: Tensile
Temperature rise rate: 3° C./min
Frequency: 1 Hz
Setting strain: 0.1%.
Environment: Nitrogen

The following raw materials were used for the experiment.
Transition metal compound (1)

(Synthesized by the method described in Japanese Unexamined Patent Publication No. 2004-331965.)

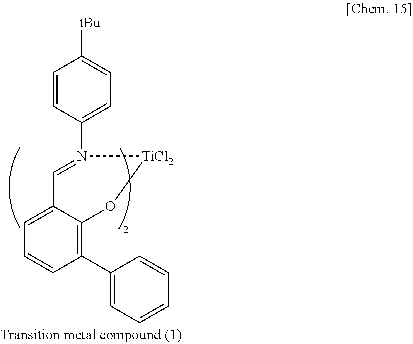

Methylaluminoxane (manufactured by Tosoh Finechem Corporation: 5.6 wt % MAO hexane solution)

Toluene (manufactured by Wako Pure Chemical Industries, Ltd.: Wako special grade)

5-vinyl-2-norbornene (manufactured by Tokyo Chemical Industry Co., Ltd.)

Tetracyclo[4.4.0.1^{2,5}.1^{7,10}]-3-dodecene (manufactured by Mitsui Chemicals, Inc.)

2-norbornene (manufactured by Tokyo Chemical Industry Co., Ltd.)

Percumyl D (manufactured by NOF Corporation)

### Synthesis Example 1

In a 1 L internal volume autoclave made of SUS sufficiently substituted with nitrogen, 359 mL of toluene, 71.8 mL of 5-vinyl-2-norbornene (VNB), 42.5 mL of tetracyclododecene (TD), 26.4 mL of a 5 M toluene solution of 2-norbornene (NB), and 1.5 mmol of methylaluminoxane in terms of aluminum were charged, the solution was heated to 35° C., then 558 mL of hydrogen was added thereto, and ethylene was introduced into the system until a total pressure of 0.52 MPa was reached.

Next, 2.35 mL of a 0.002 M toluene solution of a transition metal compound (1) was added and the polymerization was started. After 50 minutes of reaction at 35° C., 4.65 mL of a 0.002 M toluene solution of the transition metal compound (1) was added thereto and made to react for 30 minutes, then, 4.65 mL of the 0.002 M toluene solution of transition metal compound (1) was added again and made to react for another 30 minutes.

Thereafter, a small amount of methanol was added to stop the polymerization. After the polymerization was finished, 85 g of ion exchange water was added to some of the reactants and stirred for 1 hour, then the organic layer was filtered through filter paper. The organic layer was added to 1.6 L of acetone to precipitate the polymer and the result was stirred and filtered through a filter paper.

After drying the obtained polymer at 80° C. for 10 hours under reduced pressure, an ethylene/TD/NB/VNB copolymer was obtained. The composition ratio of the NB-derived structure in the polymer determined by NMR was 10.2 mol %, the composition ratio of the TD-derived structure was 11.4 mol %, and the composition ratio of the VNB-derived structure was 26.0 mol %.

### Synthesis Examples 2 to 10

Polymerization was performed under the conditions shown in Table 1 in the same procedure as in [Synthesis Example 1], respectively, and cyclic olefin copolymers were obtained.

TABLE 1

| | Synthesis | Synthesis | Synthesis | Synthesis | Synthesis | Synthesis | Synthesis | Synthesis | Synthesis | Synthesis |
|---|---|---|---|---|---|---|---|---|---|---|
| | Example 1 | Example 2 | Example 3 | Example 4 | Example 5 | Example 6 | Example 7 | Example 8 | Example 9 | Example 10 |
| Toluene (mL) | 359 | 357 | 333 | 344 | 351 | 340 | 380 | 377 | 342 | 315 |
| VNB (mL) | 71.8 | 66.7 | 37.2 | 29.5 | 110.5 | 110.5 | 94.2 | 72.5 | 76.2 | 10.4 |
| TD (mL) | 42.5 | 28.3 | 28.3 | 72.2 | 25.8 | 35.0 | 25.6 | 50.5 | 73.3 | 15.2 |
| NB (mL) | 26.4 | 48.2 | 101.2 | 54.7 | 12.7 | 81.6 | 0 | 0 | 8.9 | 159.6 |
| Constituent | 10.2 | 15.4 | 28.9 | 20.1 | 5.1 | 16.8 | 0 | 0 | 3.1 | 50.0 |
| unit (C) NB | | | | | | | | | | |
| (mol %) | | | | | | | | | | |
| Constituent | 11.4 | 6.6 | 7.2 | 17.5 | 4.8 | 13.8 | 6.5 | 15.0 | 17.1 | 3.7 |
| unit (D) TD | | | | | | | | | | |
| (mol %) | | | | | | | | | | |
| Constituent | 26.0 | 22.5 | 11.5 | 9.7 | 33.5 | 10.4 | 35.9 | 27.7 | 24.9 | 3.1 |
| unit (B) VNB | | | | | | | | | | |
| (mol %) | | | | | | | | | | |
| (B + C)/D | 3.18 | 5.74 | 5.61 | 1.70 | 8.04 | 1.97 | 5.52 | 1.85 | 1.64 | 14.35 |
| B/(B + C + D) | 0.55 | 0.51 | 0.24 | 0.21 | 0.77 | 0.25 | 0.85 | 0.65 | 0.55 | 0.05 |

### Example 1

To a sample tube having a stirring bar therein, 0.5 g of the ethylene/TD/NB/VNB copolymer obtained in Synthesis Example 1 and 0.5 g of toluene were added, and a solubility test was performed by stirring with a magnetic stirrer at room temperature. The results are shown in Table 2.

In the table, when the polymer was completely dissolved and the sample tube was tilted at room temperature, a case where the obtained solution flowed easily was classified as ⊚ (extremely good) and classified as ◯ (good) if not. In addition, a case where the polymer did not dissolve completely and there was residue was classified as ×(bad).

In a 200-mL separable flask, 7 g of the ethylene/TD/NB/VNB copolymer obtained in Synthesis Example 1, 0.147 g of Percumyl D, and 28 g of toluene were charged, stirring was carried out with a stirring blade at a rotation speed of 200 rpm for 4 hours until the above was sufficiently dissolved, and the desired varnish-like cyclic olefin-based copolymer composition was obtained.

The obtained varnish-like cyclic olefin-based copolymer composition was coated onto a release-treated PET film at a rate of 10 mm/sec and then dried at 150° C. for 4 minutes in a blower dryer under a nitrogen stream. Two of the obtained films were overlaid, pressed to 3.5 MPa by vacuum pressing, heated from room temperature (25° C.) at a constant rate, and held at 180° C. for 120 minutes to obtain a laminated film. Dielectric loss tangent measurement and Tg measurement were performed on the obtained laminated film. The obtained results are shown in Table 2.

### Examples 2 to 6 and Comparative Examples 1 to 4

The cyclic olefin copolymers obtained in Synthesis Examples 2 to 10 were subjected to solubility tests and dielectric loss tangent evaluation, respectively, according to the same procedures as in Example 1. The results are shown in Table 2.

TABLE 2

| | Example | Example | Example | Example | Example | Example | Comparative | Comparative | Comparative | Comparative |
|---|---|---|---|---|---|---|---|---|---|---|
| | 1 | 2 | 3 | 4 | 5 | 6 | Example 1 | Example 2 | Example 3 | Example 4 |
| Copolymer | Synthesis | Synthesis | Synthesis | Synthesis | Synthesis | Synthesis | Synthesis | Synthesis | Synthesis | Synthesis |
| | Example | Example | Example | Example | Example | Example | Example 7 | Example 8 | Example 9 | Example 10 |
| | 1 | 2 | 3 | 4 | 5 | 6 | | | | |
| (B + C)/D | 3.18 | 5.74 | 5.61 | 1.70 | 8.04 | 1.97 | 5.52 | 1.85 | 1.64 | 14.35 |
| B/(B + C + | 0.55 | 0.51 | 0.24 | 0.21 | 0.77 | 0.25 | 0.85 | 0.65 | 0.55 | 0.05 |
| D) | | | | | | | | | | |
| Solubility | ◯ | ⊚ | ⊚ | ◯ | ⊚ | ⊚ | X | X | X | X |
| Tg (° C.) | 183 | 167 | 142 | 177 | 186 | 149 | 186 | 187 | 196 | 109 |
| Dielectric | 0.0032 | 0.0028 | 0.0018 | 0.0024 | 0.0037 | 0.0017 | 0.0056 | 0.0035 | 0.0033 | 0.0015 |
| loss tangent | | | | | | | | | | |

This application claims priority based on Japanese Patent Application No. 2020-009678 filed on Jan. 24, 2020, and the entirety of the disclosure is incorporated herein.

1. A cyclic olefin copolymer comprising:
one or more olefin-derived constituent units (A) represented by General Formula (I);
one or more cyclic olefin-derived constituent units (C) represented by General Formula (II);
one or more cyclic non-conjugated diene-derived constituent units (B) represented by General Formula (III); and
one or more cyclic olefin-derived constituent units (D) represented by General Formula (V),
wherein, when a total number of moles of the constituent units in the cyclic olefin copolymer is 100 mol %, a content of the constituent unit (C) is 5 mol % or more and 40 mol % or less, 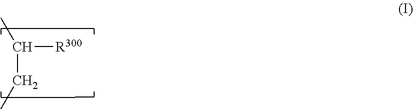
in General Formula (I), R³⁰⁰ represents a hydrogen atom or a linear or branched hydrocarbon group having 1 to 29 carbon atoms, 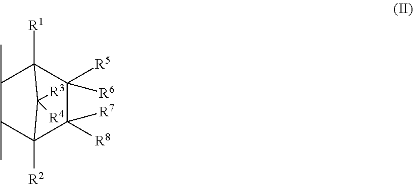
in General Formula (II), R¹ to R⁸ are each independently a hydrogen atom, a halogen atom, or a hydrocarbon group having 4 or less carbon atoms, R⁵ to R⁸ may be bonded to each other to form a monocyclic ring and the monocyclic ring may have a double bond, and an alkylidene group may be formed by R⁵ and R⁶ or R⁷ and R⁸, 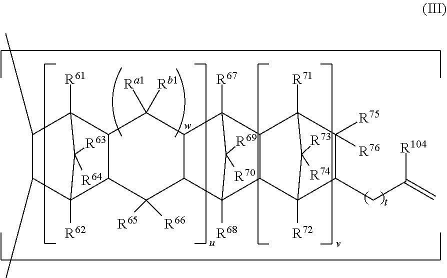
in General Formula (III), u is 0 or 1, v is 0 or a positive integer, w is 0 or 1, R⁶¹ to R⁷⁶ and R^{a1} and R^{b1} may be the same as or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded with each other to form a monocyclic ring or polycyclic ring, 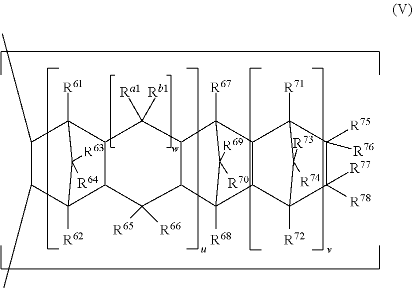
in General Formula (V), u is 0 or 1, v is 0 or a positive integer, u+v is a positive integer, w is 0 or 1, R⁶¹ to R⁷⁸ and R^{a1} and R^{b1} may be the same as or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or polycyclic ring.

2. The cyclic olefin copolymer according to claim 1,
wherein a ratio ((B+C)/D) of a sum of a content of the constituent unit (B) and a content of the constituent unit (C) to a content of the constituent unit (D) in the cyclic olefin copolymer is 1.75 or more.

3. The cyclic olefin copolymer according to claim 1,
wherein a ratio (B/(B+C+D)) of a content of the constituent unit (B) to a sum of a content of the constituent unit (B), a content of the constituent unit (C), and a content of the constituent unit (D) in the cyclic olefin copolymer is 0.75 or less.

4. The cyclic olefin copolymer according to claim 1,
wherein a cyclic non-conjugated diene forming the cyclic non-conjugated diene-derived constituent unit (B) includes at least one selected from 5-vinyl-2-norbornene and 8-vinyl-9-methyltetracyclo[4.4.0.1^{2,5}.1^{7,10}]-3-dodecene.

5. The cyclic olefin copolymer according to claim 1,
wherein a cyclic non-conjugated diene forming the cyclic non-conjugated diene-derived constituent unit (B) includes 5-vinyl-2-norbornene.

6. The cyclic olefin copolymer according to claim 1,
wherein a cyclic olefin forming the cyclic olefin-derived constituent unit (C) includes bicyclo[2.2.1]-2-heptene.

7. The cyclic olefin copolymer according to claim 1,
wherein a cyclic olefin forming the cyclic olefin-derived constituent unit (D) includes tetracyclo[4.4.0.1^{2,5}.1^{7,10}]-3-dodecene.

8. The cyclic olefin copolymer according to claim 1,
wherein an olefin forming the olefin-derived constituent unit (A) includes ethylene.

9. A cyclic olefin-based resin composition comprising:
the cyclic olefin copolymer according to claim 1.

10. The cyclic olefin-based resin composition according to claim 9, further comprising:
a solvent,
wherein the cyclic olefin-based resin composition is varnish-like.

11. The cyclic olefin-based resin composition according to claim 9, further comprising:
a radical polymerization initiator.

12. A cross-linked product formed by cross-linking the cyclic olefin copolymer according to claim 1.

13. A formed article comprising:
the cross-linked product according to claim 12.

14. The formed article according to claim 13 which is a film or sheet.

15. The formed article according to claim 13, which is a high frequency circuit substrate or a substrate for a liquid crystal display.

16. A cross-linked product formed by cross-linking the cyclic olefin copolymer according to claim 9.

17. A formed article comprising:
the cross-linked product according to claim 16.

18. The formed article according to claim 17 which is a film or sheet.

19. The formed article according to claim 17, which is a high frequency circuit substrate or a substrate for a liquid crystal display.
